(19) United States
(12) Patent Application Publication
(10) Pub. No.: US 2006/0016750 A1
(43) Pub. Date: Jan. 26, 2006

(54) Process for regenerating facilitated-transport membranes

(75) Inventors: Tim Charles Merkel, Menlo Park, CA (US); Roland J. Blanc, Vernaison (FR)

Correspondence Address: MEMBRANE TECHNOLOGY AND RESEARCH INC., 1360 WILLOW ROAD SUITE 103, MENLO PARK, CA, 94025-1516, US

(73) Assignee: Membrane Technology and Research Inc., Menlo Park, CA (US)

(21) Appl. No.: 11/182,107

(22) Filed: Jul. 15, 2005

Related U.S. Application Data
(60) Provisional application No. 60/589,948, filed on Jul. 20, 2004.

(51) Int. Cl. B01D 61/38

(52) U.S. Cl. 210/638; 210/643; 210/639

(57) ABSTRACT

A process for regenerating a facilitated-transport membrane, such as a gas separation membrane, that contains an ionic complexing agent, and that has lost performance as a result of reduction of at least some of the ions to a less charged or uncharged form. The process involves exposing the membrane to an oxidizing agent, such as hydrogen peroxide. The invention also includes membranes that have been regenerated in this way, and their use, particularly for separating light olefins from light paraffins by membrane gas separation.

This application claims the benefit of U.S. Provisional Application Ser. No. 60/589,948, filed Jul. 20, 2004 and incorporated herein by reference.

This invention was made in part with Government support under award number DMI-0419401, awarded by the National Science Foundation. The Government has certain rights in this invention.

### FIELD OF THE INVENTION

The invention relates to facilitated-transport membranes, such as gas separation membranes. More particularly, the invention relates to regeneration of such membranes if separation performance has deteriorated.

### BACKGROUND OF THE INVENTION

Facilitated-transport separation membranes employ a carrier in the membrane that selectively complexes with one of the components of the feed fluid. Permeation across a facilitated-transport membrane takes place by a combination of uncomplexed and complexed transport. Uncomplexed transport is by normal solution/diffusion of uncomplexed molecules. Complexed transport takes place only for components that react chemically with the carrier agent, and may involve hopping of those components from site to site if the carrier is fixed, or diffusion of the component-carrier complex if the carrier is mobile. The total transmembrane flux of the component is the sum of the complexed and uncomplexed fluxes.

It is well known that a variety of complexing agents, including metal ions, such as silver, can react selectively and reversibly with unsaturated hydrocarbons, so the use of facilitated-transport membranes to separate unsaturated from saturated hydrocarbons has been studied, in fact for more than thirty years. Nevertheless, to applicants' knowledge, no facilitated-transport membranes are in industrial use for this, or for any other separation.

The problems that have held back facilitated-transport membranes are instability and low flux. As originally developed, facilitated-transport membranes took the form of immobilized liquid membranes (ILMs). These are made by impregnating a microporous membrane with a solution of the facilitating carrier in a solvent, often water. The carrier solution is kept within the pores of the support membrane by capillary forces. Alternatively, the carrier liquid can be sandwiched between supporting membrane layers. ILMs can show extremely high selectivities under low-pressure laboratory conditions for the separation of olefins from paraffins, for example.

However, it is very hard to keep the carrier solution within the membrane and undegraded for any length of time. The stability of ILMs is very poor; the liquid membrane is driven out of the support by the applied feed pressure, the carrier solute passes into adjacent fluids on the permeate or feed side, or the solvent simply evaporates. The membranes normally had to be made very thick to last even a few hours.

To address these problems, other membrane configurations that avoid using a liquid carrier solution have been tried. These include solid ion-exchange membranes with metal counter-ions, dispersions into non-porous polymer matrices of salts that exhibit facilitated transport, and dispersion of metal salts in dissociated form in solid polymer solutions. Some of these, especially the last, show good separation performance and are stable, in that the carrier does not evaporate and is not blown out of the membrane by a high pressure difference across the membrane.

Nevertheless, problems remain. A significant unresolved issue is loss of carrier performance caused by reduction of the ionized carrier to non-ionized form, such as an elemental metal. Such reduction can occur by exposure to light, hydrogen or other reducing agents. If the reducing agent is present in the feed to the membrane system, even in very low concentrations, a progressive decrease in separation performance may occur. After a relatively short period, the membrane selectivity may have dropped so low that the membrane is no longer able to perform a useful separation.

This problem has been known for many years, certainly since the work on supported liquid membranes by Hughes, Steigelmann et al. at Standard Oil in the early 1970s.

In the intervening thirty years, a few efforts to retard the reduction process have been reported. U.S. Pat. No. 4,014,665, to Standard Oil, describes a supported liquid membrane in which hydrogen peroxide is added to an aqueous membrane solution containing silver salts to slow reduction of the silver ions to uncharged silver atoms.

U.S. Pat. No. 6,645,276, to Korea Institute of Science and Technology, describes addition of a non-volatile surfactant to maintain the activity of a metal salt in a solid polymer electrolyte membrane. Membranes incorporating the surfactant are reported to show no deterioration in performance when exposed to ultraviolet light.

U.S. Pat. No. 6,706,771, also to Korea Institute of Science and Technology, describes addition of phthalate compounds, such as di-alkyl phthalates, to solid facilitated-transport membranes. The phthalate allegedly binds with the silver ions to improve their stability.

A paper by J. H. Kim et al. entitled “Facilitated transport of ethylene across polymer membranes containing silver salt: effect of HBF₄ on the photoreduction of silver ions”, (Journal of Membrane Science, 212, pages 283-288, 2003) describes addition of tetrafluoroboric acid (HBF₄) to solid polymer electrolyte membranes to retard reduction of silver ions in a poly-(2-ethyl-2-oxazoline) polymer matrix caused by a reaction between the polymer, salt and water.

To applicants' knowledge, no processes are known for regenerating membranes by restoring to the ionic form a carrier that has been reduced to the uncharged form.

### SUMMARY OF THE INVENTION

The invention has three aspects: a process for regenerating a facilitated-transport membrane; a facilitated-transport membrane thus regenerated; and a separation process using the regenerated membrane.

In the first aspect, the invention is a process for regenerating a facilitated-transport membrane that contains or contained an ionic complexing agent, and that has lost performance as a result of partial or total reduction of that agent to a less charged or uncharged, inactive form.

The membrane to be regenerated may be any type of facilitated-transport membrane that contains a reducible ionized carrier as facilitating agent. The process is applicable to solid or liquid facilitated-transport membranes, regardless of the form that the membranes take. Usually the membrane will include a porous or non-porous polymer matrix to contain the carrier agent.

The membrane may be in any convenient configuration. A preferred configuration for the membranes is as flat sheet membranes rolled into spiral-wound modules.

The invention is intended to be particularly applicable to membranes containing metal ions as facilitating agents. Such membranes may be used to separate unsaturated hydrocarbons, such as olefins, from gas and liquid mixtures by preferentially permeating the unsaturated component. Many different metal ions are able to form complexes with unsaturated hydrocarbons; silver has been most widely used in membrane development, but many other carriers are known.

Membranes containing metal ions are susceptible to loss of performance because the metal ion is easily reducible to the uncharged elemental metal.

The invention is expected to be especially useful for regenerating solid facilitated-transport membranes in which the carrier is dispersed in an amorphous polymer. These types of membrane include the membranes containing dissociated metal salt carriers discussed in U.S. Pat. No. 5,670,051.

Surprisingly, we have found that damage to facilitated-transport membranes by reducing agents is at least partially reversible, and that permeance and selectivity for the preferentially permeating component can be substantially restored by exposure of the damaged membranes to oxidizing agents.

Thus, in its first aspect, the invention involves exposing the membranes to an oxidizing agent. The oxidizing agent may be any agent that is effective to restore the carrier from uncharged inactive form to ionized active form. A preferred oxidizing agent is hydrogen peroxide.

It is also preferred to add an acid to the oxidizing agent. A particularly preferred oxidizing agent composition includes a mixture of hydrogen peroxide and tetrafluoroboric acid (HBF₄).

The oxidizing agent can be applied to the membranes as a vapor or liquid. This can be done by placing the membrane in a static liquid or vapor atmosphere, or by running a flow of liquid or vapor containing the oxidizing agent across the membrane. Optionally, the process can be carried out while the membrane modules remain installed in housings in a separation system. This limits disruption to normal system operations, so is a particularly advantageous method of operation of the process.

The invention prolongs the useful lifetime of the membranes and avoids the need for frequent replacement of membranes that have been subject to conditions that damage their properties.

In another aspect, the invention is a membrane that has been thus regenerated. As above, the membrane may be any type of facilitated-transport membrane that contains a reducible ionized carrier as facilitating agent.

Also as above, the most preferred membrane is a solid polymer matrix in which a dissociated metal salt is dispersed, particularly as described in U.S. Pat. No. 5,670,051. The preferred configuration is again a flat sheet membrane rolled into a spiral-wound module.

In a third aspect, the invention is a separation process using the regenerated membrane. Preferably, the process involves separation of unsaturated hydrocarbons from hydrocarbon or other fluid mixtures.

In a representative basic embodiment of this preferred separation, the process includes the following steps:
(a) providing a facilitated-transport membrane that contains metal ions as a facilitating agent and that has been at least partially inactivated by reduction and regenerated by oxidation, the facilitated-transport membrane having a feed side and a permeate side;
(b) providing a driving force for transmembrane permeation;
(c) passing the fluid mixture as a feed stream across the feed side; and
(d) withdrawing from the permeate side a permeate fluid mixture enriched in the unsaturated hydrocarbon compared with the feed stream.

Again, the preferences stated above apply. In other words, the membrane is preferably a solid polymer membrane containing dissociated metal ions as carrier agent, and taking the configuration of a flat sheet membrane in a spiral-wound module.

The process can be carried out as a gas separation process. This is most useful when the unsaturated hydrocarbon is a light olefin, such as ethylene, propylene or butene.

The process can also be carried out as a liquid phase process, preferably pervaporation, and in this mode is suited to separate heavier unsaturated hydrocarbons, such as C₃₊ olefins or aromatics.

The unsaturated hydrocarbons to be separated may be in a mixture with any other gas or liquid components. However, the process is particularly useful in separating streams containing mixtures of unsaturated and saturated hydrocarbons, such as olefins and paraffins.

It is to be understood that the above summary and the following detailed description are intended to explain and illustrate the invention without restricting its scope.

### BRIEF DESCRIPTION OF THE DRAWING

FIG. 1 is a graph showing the mixed-gas selectivity for ethylene/ethane of a facilitated-transport membrane that has been exposed to hydrogen gas and subsequently regenerated.

### DETAILED DESCRIPTION OF THE INVENTION

The term fluid as used herein means gas, vapor or liquid.

The term gas as used herein means gas or vapor.

The term unsaturated hydrocarbon means a compound comprising carbon and hydrogen with at least one carbon-carbon double bond or one carbon-carbon triple bond.

The term olefin means a member of the family of unsaturated hydrocarbons with a carbon-carbon double bond of the series CₙH₂ₙ.

The term paraffin means a member of the family of saturated aliphatic hydrocarbons of the series CₙH₂ₙ₊₂.

The term selectivity as used herein means, unless otherwise qualified, the selectivity of a membrane as measured with a fluid mixture containing at least the two components to which the selectivity refers.

The terms facilitating agent, complexing agent and carrier agent are used interchangeably herein to mean the component of a facilitated-transport membrane that can react with the component of the feed mixture that is to be permeated preferentially, and thereby facilitate its transport across the membrane.

The invention has three aspects: a process for regenerating a facilitated-transport membrane; a facilitated-transport membrane thus regenerated; and a separation process using the regenerated membrane.

In the first aspect, the invention is a process for regenerating a facilitated-transport separation membrane.

The scope of the invention is not intended to be limited to any particular membranes, but to cover any situation where a membrane contains an ionic complexing agent to facilitate transport across the membrane of a preferred species, and where the membrane has lost performance as a result of reduction of facilitating agent to an inactive form. The reduction may have lowered the degree of charge of some or all of the complexing ions, such as from the ²⁺ state to the ¹⁺ state, or may have fully reduced some or all of them to uncharged form.

Likewise, the scope of the invention is not limited to membranes used for any particular separations, although it is expected to be especially useful in the field of hydrocarbon separations. For simplicity and clarity, therefore, the invention is described hereafter as it relates to such membranes and separations. Those of skill in the art will appreciate that the teachings given below would be equally applicable to facilitated-transport membranes in which the ionic carrier has been tailored to other separation needs, such as to remove carbon dioxide, or to separate oxygen from nitrogen.

The ionic complexing agent is typically, although not necessarily, a metal ion. Many metals, and specifically many of the transition metals of groups 3 through 12 of the Periodic Table, are able to form complexes with unsaturated hydrocarbons. These metals include, for example, copper, manganese, nickel, iron, silver, platinum and palladium.

The metal ion preferably forms the cation of a metal salt. The range of anions that can be used to complete the salt is large. A limiting criterion is that the salt needs to be at least partially dissociated when the membrane is in use, so that the cation can complex with the hydrocarbon species that it is desired to separate.

If the membrane is in the form of an aqueous liquid membrane or a solid membrane operated in a humidified environment, the salt should be water-soluble. The most widely reported anion in such membranes is nitrate, for example in the liquid membranes described in U.S. Pat. Nos. 3,758,603 and 3,758,605, to Standard Oil, and in the polymer/salt membranes described in U.S. Pat. Nos. 5,015,268 and 5,062,866, to Exxon. Other salt anions for which data have been reported and that might be found in the membrane to be regenerated include, but are not limited to, chlorides, chlorates (ClO₄), hexafluorophosphate (PF₆), CF₃SO₃ and tetrafluoroborate (BF₄).

If the membrane is in the form of a solid polymer solution, that is, a polymer matrix in which the salt is disassociated even in a dry environment, then the salt combinations are likely to be those described in U.S. Pat. No. 5,670,051, which is incorporated herein by reference in its entirety. In this case, the salt is preferably a soft acid/soft base combination, with the preferred metal ion being selected from the table in column 8 of 5,670,051 and the preferred soft base being selected from the table in column 9 of 5,670,051.

The invention is especially useful for regenerating membranes in which the facilitated carrier ion is silver, which is quite susceptible to reduction to elemental silver, and the anion is tetrafluoroborate or nitrate.

Although the regeneration process can be applied to liquid facilitated-transport membranes, and such regeneration is within the scope of the invention, these membranes suffer from so many other problems that use of the process in this area is not expected to be particularly valuable.

We believe that membranes in which the carrier is incorporated into a solid polymer matrix are more likely to be used outside the laboratory, and the process is likely to be most beneficial when applied to such membranes. In this case, the polymer matrix may be made from any material appropriate to the specific type of membrane and carrier agent.

Representative appropriate polymers are discussed in the literature that describes the different types of solid facilitated-transport membranes, including U.S. Pat. Nos. 4,318,714, 5,015,268, 5,062,866, 4,614,524, 5,670,051, 6,468,331 and 6,645,276, U.S. patent application Publication 2004/0200355 and in K.-V. Peinemann et al. (“Preparation and Properties of Highly Selective Inorganic/Organic Blend Membranes for Separation of Reactive Gases”, Proceedings of the 1990 International Congress on Membranes and Membrane Processes, Vol. 1, pages 792-794, 1990).

Because the preferred membranes are those described in U.S. Pat. No. 5,670,051, the preferred polymers for the polymer matrix are those described in that patent, and the most preferred polymers are the polyamide-polyether block copolymer sold commercially the name PEBAX®, and having the general formula 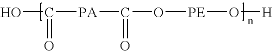
where PA is a polyamide segment, PE is a polyether segment and n is a positive integer.

The membranes to be regenerated may be in any convenient configuration. If the membranes are liquid membranes, they normally take the form of an aqueous solution either held in the pores of a microporous membrane, or sandwiched between microporous membranes.

If the membranes are solid membranes, they are usually in the form of flat sheet or hollow-fiber membranes. These may be unpackaged, but more likely will be packaged into one of the known membrane module types, including, but not limited to, potted hollow fibers, or for flat sheet membranes, plate-and-frame modules or spiral-wound modules.

Preferably the membranes are flat sheet membranes in spiral-wound modules.

Whatever its form, the membrane to be regenerated has lost performance because the ionic complexing agent has been reduced to an uncharged, inactive form. Usually the most significant symptom of such reduction is that the selectivity of the membranes has dropped. This drop in selectivity is primarily brought about by a drop in permeance (pressure-normalized flux) of the permeant that reacts with the complexing agent. An increase in permeance of components that do not react with the complexing agent, but permeate by diffusion through the polymer matrix, may also occur, further depressing the selectivity.

The membrane may also change color. For example, membranes containing silver cations typically turn brown or black as the silver is reduced.

The extent to which the membrane performance has been impaired is an indication of the extent to which the complexing agent has become inactivated by reduction. The process can be applied to membranes suffering from any degree of reduction, from very slight (a loss of selectivity of only a few percent) to severe (total or almost total loss of the selectivity arising from the facilitating/complexing mechanism).

The manner in which reduction of the ionic carrier agent has occurred is not a limiting aspect of the invention. Any environment in which electrons are available to be captured by the ionic complexing agent may potentially cause it to revert to a lower-charged or non-charged state. Common reducing agents for metal cations include electromagnetic radiation, such as light and UV radiation, hydrogen, acetylene, hydrides, and other metals of lower ionization energy.

Of these, at least one, such as hydrogen or acetylene, it often present in the mixed hydrocarbon streams from which olefins and other unsaturated petrochemicals are produced. If the carrier ion is silver, for example, reactions such as
2Ag⁺+H₂→2Ag⁰+2H⁺
may occur. Even if steps have been taken to remove the reducing component upstream of the membrane separation system, enough may remain in the stream to cause damage over time.

After membranes have been made, but before they have been incorporated into modules or housings, they may be exposed to UV components of light, enabling the following type of reaction
Ag⁺+e⁻→Ag⁰
to take place.

Thus, many environments present hazards that are potentially damaging to membranes.

The oxidizing agent may be any agent that restores at least some of the reduced carrier agent to ionized, active form. The relative standardized oxidation potentials of a few common oxidizing agents are shown in Table 1.

| | Standard oxidation |
|---|---|
| Oxidant | potential (volts) |
| Fluorine | 3.0 |
| Hydroxyl | 2.8 |
| Ozone | 2.1 |
| Hydrogen peroxide | 1.8 |
| Potassium permanganate | 1.7 |
| Chlorine dioxide | 1.5 |
| Chlorine | 1.4 |

Including those in the table above, many reagents with oxidizing capability are known, ranging from fluorine (the strongest) to agents that may act as very mild oxidizing or reducing agents, depending on the oxidation state of the material they are to react with. Cations of transition metals fall into this latter group of weakly oxidizing agents.

Relatively strong oxidizing agents include ozone, oxygen, hydroxyl ions and chlorine. Yet other relatively strong oxidizing agents include other halogens, such as bromine, and other compounds containing oxygen, such as peroxides, particularly hydrogen peroxide, and peroxyacids (RCO₃H), such as peroxysulfuric acid or peroxyacetic acid.

Moderately strong oxidizing agents include oxygen-rich salts, such as those containing permanganate (MnO₄⁻), chromate (CrO₄²⁻), and dichromate (Cr₂O₇²⁻) ions, and acids, such as nitric acid (HNO3), perchloric acid (HClO₄), and sulfuric acid (H₂SO₄).

The mildest oxidizing agents include cations of transition metals, such as Cu²⁺ and CO³⁺.

The oxidizing agent chosen should be strong enough to re-ionize the carrier agent, but not so strong as to form an oxide or other stable compound with it. As a general guideline, preferred oxidizing agents are those in the medium to strong range of oxidizing activity, such as oxygen, ozone, the peroxyacids, hydrogen peroxide and oxygen-rich salts and acids. Any of these may be useful, depending on the relative electronegativity of the carrier agent and the oxidizing agent, and any of these can be tested for efficacy by simple experiments as described below in the Examples section.

If the carrier agent to be regenerated is silver, chlorinated oxidizing agents, including chlorine, chlorine dioxide and hypochlorites should be avoided, as they tend to form stable silver chloride, which is not active as a facilitating agent.

The oxidizing agent may be used alone or as one or more components of an oxidizing mixture.

It is preferred to add an acid, such as, but not limited to, nitric acid, acetic acid or tetrafluoroboric acid, to the oxidizing agent. This may help both to stabilize the oxidizing agent, as well as to speed up the oxidation process, increase the oxidation capability, or both.

It is also preferred to include liquid water or water vapor in the oxidizing mixture, as this also appears to facilitate the oxidation process. This may easily be done by preparing the oxidizing agent in aqueous solution.

A particularly preferred oxidizing agent is hydrogen peroxide. Hydrogen peroxide is more stable in an acid environment, so hydrogen peroxide/acid mixtures are particularly preferred and result in faster regeneration than use of hydrogen peroxide alone.

If the facilitated-transport carrier agent is silver, the most preferred oxidizing agent is a hydrogen peroxide/tetrafluoroboric acid mixture. Ideally the peroxide and acid should be present in about equal proportions (that is, between about 40 wt % acid to 60 wt % acid) to achieve the fastest regeneration rate.

Typically these reagents are available only in aqueous solutions, with the concentration of the reagent no higher than about 50 wt %. Therefore, the preferred oxidizing agent mixtures will often contain at least about 50 wt % water. This is not a problem, as water is also a preferred component of the mixture. In general, however, it is also preferred that the oxidizing agent and acid should together make up at least about 30 wt %, 40 wt % or more of the mixture.

The oxidizing agent can be applied to the membranes as a vapor or liquid, using any convenient technique that provides adequate exposure of the membrane to the oxidizing environment. Representative, non-limiting methods by which this may be done are described below; others may suggest themselves to those of skill in the art.

If the membranes are unpackaged, and particularly if they take the form of individual fibers, sheets or stamps, they may simply be placed in the oxidizing environment. For example, they may be lowered into a container holding a solution of the agent, or suspended in the vapor space above or adjacent to a solution of the agent.

The membranes may be held in the oxidizing environment as long as is needed to achieve the desired regeneration. In general, immersion in a liquid achieves faster results than suspension in a vapor. For example, silver-containing membranes may be restored from dark brown or black to white after a liquid immersion time of a minute or less, and demonstrate a large increase in olefin permeance and olefin/paraffin selectivity. If the membranes are suspended in vapor, an exposure time of a few hours or days may be needed to achieve comparable results. Vapor exposure provides a more gentle form of treatment.

The stronger and more concentrated is the oxidizing agent, the less should be the exposure time, both in terms of time needed to regenerate the membranes and to avoid other damage to the membranes. For example, membranes should be immersed in concentrated (more than 20 wt % oxidizing agent or oxidizing agent plus acid content) solutions of oxidizing agent for no more than a few minutes, preferably no more than 10 minutes and more preferably no more than about 5 minutes. Prolonged exposure may affect the membranes physically, such as delaminating the selective layer from the support layer of a composite membrane, or reacting chemically with the polymer(s) used to make the membrane or with other components, such as glues, spacers and the like if the membrane is already housed in a module.

If the membranes have already been assembled into modules, such as plate-and-frame, hollow-fiber or spiral-wound modules, they may be treated by running a flow of liquid or vapor containing the oxidizing agent through the modules. This may be done simply by orienting the modules vertically, so that the feed inlet is higher than the residue and permeate outlets, and pouring the liquid oxidizing solution through the modules on the feed or permeate sides, or both.

As another non-limiting example, the module(s) can be mounted in a permeation apparatus and the oxidizing agent may be run as a liquid or vapor across the feed side. In some cases, it may be preferred to run the oxidizing agent into the modules on the permeate side, as is known in the art, to back-flush ultrafiltration modules, for example. This may enhance rapid permeation of the oxidizing agent through the thickness of the membrane, because the permeate side is typically more openly porous than the feed side. The oxidizing agen may be run on both sides if desired.

If the membrane modules have already been installed in housings and mounted in a separation system, they may be treated by flowing the oxidizing agent through the modules on the feed or permeate side, or both sides, as described above. This may be done with the oxidizing agent in either liquid or vapor form. As mentioned above, however, regeneration with vapor is gentler and less likely to damage other components of the system, so vapor-phase regeneration is generally preferred.

If the agent is in liquid form, for example an aqueous solution, but it is desired to carry out the regeneration in the vapor phase, then nitrogen, air or another suitable gas may be bubbled through the solution and saturated with vapor of the oxidizing mixture. The resulting gas/vapor mixture may then be run through the system to regenerate the modules.

The regeneration process may be carried out at room temperature, such as 20-25° C. The oxidation reactions typically proceed faster at elevated temperature, however, so if a faster regeneration is required, the process can be speeded up by warming the oxidizing fluid, such as to about 40° C. or 50° C., as a non-limiting example.

An attractive feature of the invention is that the membranes may be regenerated without the need to remove them from the system or housings where they have been in operation. This limits disruption to normal system operations.

The regeneration process prolongs the useful lifetime of the membranes and avoids the need for frequent replacement of membranes that have been subject to reducing conditions.

In a second aspect, the invention is a membrane that has been regenerated by using one of the processes described above.

The membrane may be any membrane that once contained an ionic complexing agent, that lost performance as a result of reduction of at least part of that agent to an uncharged, inactive form, and that has subsequently been regenerated by oxidation of at least part of the reduced agent, thereby returning that part of the agent to an active ionized form.

As described above with relation to the regeneration process aspects of the invention, the membrane may contain a carrier useful for any separation, although preferred membranes are those that contain carrier agents adapted for complexing with unsaturated hydrocarbons.

More preferred are solid polymer membranes that contain metal salts, such as described with respect to the other aspects of the invention above, in which the metal cation serves as the complexing agent.

Most preferred are the membranes taught in U.S. Pat. No. 5,670,051, incorporating soft acid/soft base salts and using as matrix a polymer in which the salt is dissociated, and in particular membranes using silver tetrafluoroborate as the metal salt and polyamide-polyether block copolymers as the polymer matrix in which the salt is dispersed or dissolved.

The membranes may take any convenient form as described with respect to the other aspects of the invention above, although most preferably they take the form of flat sheet membranes in spiral-wound modules.

Compared with their performance before regeneration, the regenerated membranes exhibit higher permeance for components that complex with the ionized facilitating agent and higher selectivity for those components over non-complexing components.

If the membranes are adapted for the separation of an unsaturated from a saturated hydrocarbon, they preferably exhibit a permeance (pressure-normalized flux) for the unsaturated hydrocarbon, as measured with the hydrocarbon mixture under the operating conditions of the process of at least about 10 gpu, more preferably at least 20 gpu and most preferably at least about 30 gpu. Further, the membranes preferably exhibit a selectivity for the unsaturated over the saturated hydrocarbon, again measured under the operating conditions of the process, of at least about 10, and more preferably at least about 20.

In a third aspect, the invention is a separation process using the regenerated membrane. The process involves running a gas, vapor or liquid feed stream containing at least two components to be separated across the feed side of the membrane. One of the components is able to form a complex with the facilitating agent in the membrane and is transported preferentially across the membrane. A permeate stream enriched in this component is withdrawn from the permeate side of the membrane, and a residue stream depleted in the component is withdrawn from the feed side.

As regards the membrane, all of the discussion presented above as to types and preferences applies. That is, the membrane may be any membrane that contains an ionic complexing agent, but most preferably is a membrane that uses silver as the facilitating agent, silver tetrafluoroborate as the metal salt, polyamide-polyether block copolymers as the solid polymer matrix in which the salt is dispersed or dissolved, and takes the form of a flat sheet membrane in a spiral-wound module.

The separation process may be any process for which the membrane is suitable. The feed mixture may be in the form of a gas, vapor, liquid or mixed phases, and may contain two, three or more components.

Representative, non-limiting processes include separation of hydrocarbon mixtures containing saturated and unsaturated species.

Unsaturated hydrocarbons that can be separated by the regenerated membranes include those with at least one carbon-carbon double or triple bond, and may be aliphatic or aromatic. The concentration of the unsaturated hydrocarbon in the feed stream may be any value.

A separation process for which regenerated membranes are particularly useful is separation of gas or vapor streams containing mixtures of low molecular weight olefins and paraffins, such as separating ethylene from ethane, propylene from propane, or butylene from n-butane or iso-butane.

A liquid phase separation for which regenerated membranes are particularly useful is separation of aromatic compounds from saturated hydrocarbons, such as benzene from cyclohexane. Liquid phase separations are preferably done in pervaporation mode, where the feed fluid is liquid and the permeate fluid is in the gas phase.

Operational details of membrane separation processes are familiar to those of skill in the art and are well documented in the literature, including U.S. Pat. No. 5,670,051 and the other U.S. patents cited herein. No special operating conditions or configurations are necessary to use the regenerated membranes.

If the membranes are installed in a membrane separation system that had been operating before the membranes were regenerated, those operations may simply be resumed after regeneration.

The invention is now illustrated by the following examples, which are intended to further clarify understanding of the invention, but are not intended to limit the scope or underlying principles in any way.

### EXAMPLES

### Example 1

Membrane Making

An asymmetric microporous support substrate was prepared by casting a polyvinylidene fluoride (PVDF) solution onto a non-woven fabric support. A solution containing 8 wt % silver tetrafluoroborate and 2% PEBAX® 2533 in ethanol was prepared. The solution was coated onto the support using a continuous dip-coating process. After evaporation of the water, the membranes were dried completely in an oven at 70° C. and the membranes were coated with a second layer of the PEBAX solution. The membranes were then coated with a protective layer of 0.5% Teflon AF2400. The resulting solid polymer solution membranes had a selective layer with a silver salt content of 80 wt % and a thickness of about 3 μm.

Samples of membrane were cut into 13 cm² stamps and mounted in a permeation test-cell apparatus. The membranes were tested with pure ethylene and pure ethane at a feed pressure of 50 psig, a permeate pressure of 0 psig and a feed temperature of 23° C. Volumetric gas flow rates were determined with soap-bubble flowmeters. The ethylene permeance was 15 gpu (15×10⁻⁶ cm³ (STP)/cm²·s·cm Hg), and the ethane pressure-normalized flux was below the lower limit of 0.01 gpu that could be measured with our flowmeters. Thus the calculated ethylene/ethane selectivity was at least 1,500.

### Example 2

Typical Mixed Gas Properties of New Silver Membrane

Membranes prepared as in Example 1 were tested with the test-cell apparatus of Example 1 with a gas mixture of 50 vol % ethylene and 50 vol % ethane. The feed pressure was 50 psig, the permeate pressure was 0 psig and the feed temperature was 23° C. The membrane was tested for 30 minutes at a 1% stage-cut. The membrane fluxes were measured and the selectivities were calculated. The results are shown in Table 1.

TABLE 1

| | Mixed gas permeance | | |
|---|---|---|---|
| Membrane | (gpu) | | Selectivity |
| sample | C₂H₄ | C₂H₆ | C₂H₄/C₂H₆ |

| | | | |
|---|---|---|---|
| 1 | 25 | 0.66 | 37 |
| 2 | 22 | 0.65 | 33 |
| 3 | 29 | 0.78 | 37 |

As can be seen, the mixed gas ethane permeance is much higher than the pure gas measurement, and as a result, the mixed gas selectivity for ethylene/ethane is very much lower than the pure gas selectivity. This result is attributable to the membrane swelling caused by high olefin content in the membrane.

### Example 3

Properties of Aged Membranes

Membranes prepared as in Example 1 were stored in an open bag at ambient conditions for 10 months. During this time, light and chemical reducing agents present in the polymer or in the atmosphere reduced silver ions to silver metal causing the membrane to turn black and lose selectivity. A sample of aged membrane was tested as in Example 2, the fluxes were measured and the selectivities calculated. The results are shown in Table 2.

TABLE 2

| | Mixed gas permeance | | |
|---|---|---|---|
| Membrane | (gpu) | | Selectivity |
| sample | C₂H₄ | C₂H₆ | C₂H₄/C₂H₆ |

| | | | |
|---|---|---|---|
| 1 | 16 | 6.2 | 2.5 |
| 2 | 13 | 3.7 | 3.7 |

As Table 2 shows, the performance of the membranes deteriorated severely during storage. Ethylene permeance was much lower than the original value shown in Table 1 and ethane permeance increased. As a result, the selectivity was very low. These results demonstrate that silver-containing membranes suffer a marked loss of selectivity when exposed to reducing agents.

### Example 4

Regeneration of Aged Membrane by Vapor Exposure

A sample of the membrane aged as in Example 3 was placed in a sealed container with a jar containing a solution of equal weights of hydrogen peroxide solution (35 wt % hydrogen peroxide in water) and tetrafluoroboric acid (50 wt % acid in water). The container was at atmospheric pressure, so that the sample was in a vapor environment determined by the vapor pressure of the solution components. The sample was kept in the vapor atmosphere at ambient temperature overnight (about 12 hours). In the morning, the membrane samples had turned from black to white, suggesting that the elemental silver had been oxidized back to silver cations.

The regenerated membrane samples were tested as in Example 2, the fluxes were measured and the selectivities were calculated. The results are shown in Table 3.

TABLE 3

| | Mixed gas permeance | | |
|---|---|---|---|
| Membrane | (gpu) | | Selectivity |
| sample | C₂H₄ | C₂H₆ | C₂H₄/C₂H₆ |

| | | | |
|---|---|---|---|
| 1 | 29 | 0.8 | 39 |
| 2 | 22 | 0.5 | 44 |

Comparing Tables 2 and 3, it can be seen that the regeneration step substantially improved the ethylene permeance and the ethylene/ethane selectivity of the membranes.

Comparing Tables 1 and 3, it can be seen that the original permeance and selectivity properties were essentially restored by the oxidation treatment.

### Example 5

Regeneration of Aged Membrane by Vapor Exposure

The procedures of Examples 1-4 were repeated with another batch of membrane samples. The results are summarized in Table 4.

TABLE 4

| | | Mixed gas permeance | | |
|---|---|---|---|---|
| Membrane | | (gpu) | | Selectivity |
| sample | Appearance | C₂H₄ | C₂H₆ | C₂H₄/C₂H₆ |
| Aged sample 1 | Black | 16 | 6.2 | 2.5 |
| Aged sample 2 | Black | 13 | 3.7 | 3.7 |
| Regenerated 1 | White | 59 | 3.0 | 20 |
| Regenerated 2 | White | 40 | 2.5 | 16 |

In this batch, the oxidation treatment resulted in much higher ethylene fluxes. However, the ethane flux also remained relatively high, so the ethylene/ethane selectivity is a bit lower than in Example 4.

### Example 6

Regeneration of Aged Silver Membrane by Liquid Exposure

Membranes were prepared as in Example 1 and allowed to age and turn black by exposure to light as in Example 3. The exposure period was 1 month. The aged membrane samples were then directly immersed in the 50% hydrogen peroxide/50% tetrafluoroboric acid solution described in Example 3 for about 30 seconds. The membranes were removed from the oxidizing solution and dried at 50° C. for 1 hour. Thereafter, they were retested as in Example 2. The membrane fluxes were measured and the selectivities calculated. Results are shown in Table 5.

TABLE 5

| | | Mixed-gas permeance | | |
|---|---|---|---|---|
| Membrane | | (gpu) | | Selectivity |
| sample | Appearance | C₂H₄ | C₂H₆ | C₂H₄/C₂H₆ |
| Aged sample 1 | Black | 21 | 20 | 1.0 |
| Regenerated 1 | White | 48 | 1.1 | 46 |

The data presented in Table 5 demonstrate that direct immersion in a liquid oxidizing agent will regenerate aged membranes.

The data from Table 5 for membrane sample 1, before and after liquid treatment, are reproduced below in Table 6. For comparison, Table 6 also includes data for additional samples of untreated aged membranes, liquid-treated membranes and another sample of a vapor-treated membrane.

TABLE 6

| | | Mixed gas permeance | | |
|---|---|---|---|---|
| Membrane | | (gpu) | | Selectivity |
| sample | Treatment | C₂H₄ | C₂H₆ | C₂H₄/C₂H₆ |
| 1 | Untreated | 21 | 20 | 1.0 |
| | Liquid | 48 | 1.1 | 4.6 |
| 2 | Untreated | 18 | 16 | 1.1 |
| 3 | Liquid | 38 | 0.9 | 42 |
| 4 | Vapor | 21 | 1.3 | 17 |

As can be seen, vapor and liquid oxidizing treatments both regenerate membranes effectively. Oxidation takes place much faster in a liquid environment than in a vapor environment.

### Example 7

Over-Exposure of Membranes to Liquid Oxidizing Agent

Membranes were prepared as in Example 1 and aged for one 1 month as in Example 6. The aged membrane samples were then directly immersed in the 50% hydrogen peroxide/50% tetrafluoroboric acid solution described in Example 3 and left for about 10 minutes.

On inspection, the PEBAX selective layer of the membranes was found to have delaminated from the PVDF support membrane. Thus, 10 minutes is too long for safe exposure.

### Example 8

Regeneration of Membranes Aged by Exposure to Pure Hydrogen

Membranes samples prepared as in Example 1 were mounted in the test-cell apparatus of Example 1 and exposed to a mixed gas feed of 50% ethylene and 50% ethane. The membrane fluxes were measured and the selectivities calculated.

The samples were then exposed to pure hydrogen gas by running the gas through the test cell in dead-end mode at 20 psig for six days. The fluxes were measured several different times during the exposure period. At the beginning of day seven, a final set of flux measurements were made.

The membrane samples were then removed from the hydrogen gas, placed in a sealed container and treated with vapors from the 50% hydrogen peroxide/50% tetrafluoroboric acid solution described in Example 4 for about 60 hours.

On day ten, the membrane samples were remounted in the test cell, the membrane fluxes were measured again and the selectivities were calculated.

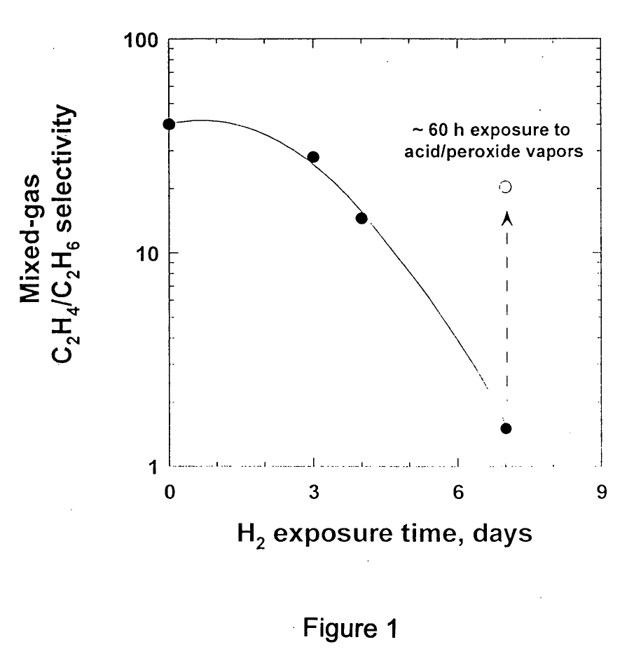

FIG. 1 plots measurements taken during the six days of hydrogen exposure and after the 60-h vapor treatment. The figure demonstrates that the 60 hours of exposure to vapors was able to regenerate the membrane and restore selectivity to a level approaching the selectivity of new membrane.

Comparing this example with Examples 4 and 5, it is apparent that membranes reduced by being exposed to hydrogen required a substantially longer regeneration time than those exposed to light. It may be that reduction had occurred throughout the thickness of the membranes exposed to hydrogen, whereas reduction was more limited to the surface in the case of light damage.

### Example 9

Suitability of Calcium Hypochlorite as an Oxidizing Agent

A solution containing 8 wt % silver tetrafluoroborate and 2% PEBAX® 2533 in ethanol was prepared. A few grams of calcium hypochlorite powder were mixed into the solution. A white precipitate of silver chloride formed immediately and settled to the bottom of the solution.

This test shows that calcium hypochlorite would not be suitable as an oxidizing agent to regenerate membranes containing silver tetrafluoroborate.

We claim:

1. A process for regenerating a facilitated-transport membrane that contains metal ions as a facilitating agent, and wherein at least some metal ions have been reduced, thereby at least partially inactivating the facilitated-transport membrane, the process comprising exposing the facilitated-transport membrane to an oxidizing agent.

2. The process of claim 1, wherein the metal ions comprise silver ions.

3. The process of claim 1, wherein the facilitated-transport membrane comprises a solid polymer membrane.

4. The process of claim 1, wherein the metal ions are from a salt.

5. The process of claim 4, wherein the salt comprises silver tetrafluoroborate.

6. The process of claim 1, wherein the oxidizing agent comprises an agent selected from the group consisting of oxygen, ozone, peroxyacids, hydrogen peroxide, salts containing at least three oxygen atoms and acids containing at least three oxygen atoms.

7. The process of claim 1, wherein the oxidizing agent comprises hydrogen peroxide.

8. The process of claim 1, wherein the oxidizing agent comprises an acid.

9. The process of claim 8, wherein the acid comprises tetrafluoroboric acid.

10. The process of claim 8, wherein the acid comprises nitric acid.

11. The process of claim 1, wherein the oxidizing agent comprises a solution of hydrogen peroxide and tetrafluoroboric acid.

12. The process of claim 1, wherein the oxidizing agent is in the vapor phase.

13. The process of claim 1, wherein the oxidizing agent is in the liquid phase.

14. The process of claim 1, wherein the membrane is in the form of a flat sheet membrane in a spiral-would module.

15. The process of claim 14, wherein the flat sheet membrane has a feed side and wherein the exposing is carried out by flowing the oxidizing agent across the feed side.

16. The process of claim 14, wherein the spiral wound module has a feed inlet and a permeate outlet, and wherein the exposing is done by temporarily blocking the permeate outlet and admitting the oxidizing agent into the spiral-would module through the feed inlet.

17. The process of claim 1, wherein the membrane has been used to separate a gas mixture.

18. The process of claim 1, wherein the membrane has been used to separate a liquid mixture.

19. The process of claim 17, wherein the gas mixture comprises an olefin.

20. The process of claim 18, wherein the liquid mixture comprises an olefin.

21. The process of claim 1, wherein the facilitated-transport membrane has a history of exposure to hydrogen.

22. The process of claim 1, wherein the facilitated-transport membrane has a history of exposure to acetylene.

24. A facilitated-transport membrane that contains metal ions as a facilitating agent and that has been at least partially inactivated and regenerated according to claim 1.

25. A facilitated-transport membrane that once contained a complexing agent in ionic form, that lost performance as a result of reduction of at least part of the complexing agent to an inactive form, and that has thereafter been regenerated by oxidation of at least part of the inactive form, thereby returning at least part of the inactive form to an active, ionized form.

26. The facilitated-transport membrane of claim 25, wherein the metal ions comprise silver ions.

27. The facilitated-transport membrane of claim 25, wherein the facilitated-transport membrane comprises a solid polymer membrane.

28. The facilitated-transport membrane of claim 25, wherein the metal ions are from a salt.

29. The facilitated-transport membrane of claim 28, wherein the salt comprises silver tetrafluoroborate.

30. The facilitated-transport membrane of claim 25, wherein the membrane is in the form of a flat sheet membrane in a spiral-would module.

31. The facilitated-transport membrane of claim 25, wherein, after regeneration, the facilitated-transport membrane exhibits a permeance for ethylene of at least about 10 gpu.

32. The facilitated-transport membrane of claim 25, wherein, after regeneration, the facilitated-transport membrane exhibits a permeance for propylene of at least about 10 gpu.

33. The facilitated-transport membrane of claim 25, wherein, after regeneration, the facilitated-transport membrane exhibits a mixed gas selectivity for ethylene over ethane of at least about 10.

34. The facilitated-transport membrane of claim 25, wherein, after regeneration, the facilitated-transport membrane exhibits a mixed gas selectivity for propylene over propane of at least about 10.

35. A process for separating an unsaturated hydrocarbon from a fluid mixture, comprising the steps of:
(a) providing a facilitated-transport membrane that contains metal ions as a facilitating agent and that has been at least partially inactivated and regenerated according to claim 1, the facilitated-transport membrane having a feed side and a permeate side;
(b) providing a driving force for transmembrane permeation;
(c) passing the fluid mixture as a feed stream across the feed side; and
(d) withdrawing from the permeate side a permeate fluid mixture enriched in the unsaturated hydrocarbon compared with the feed stream.

36. The process of claim 35, wherein the metal ions comprise silver ions.

37. The process of claim 35, wherein the facilitated-transport membrane comprises a solid polymer membrane.

38. The process of claim 35, wherein the metal ions are from a salt.

39. The process of claim 35, wherein the salt comprises silver tetrafluoroborate.

40. The process of claim 35, wherein the feed stream and the permeate fluid mixture are both in the gas phase.

41. The process of claim 35, wherein the unsaturated hydrocarbon is ethylene.

42. The process of claim 35, wherein the unsaturated hydrocarbon is propylene.

43. The process of claim 35, wherein the process is pervaporation, that is, the feed stream is liquid and the permeate fluid mixture is in the gas phase.
